(19) United States
(12) Patent Application Publication
(10) Pub. No.: US 2016/0279608 A1
(43) Pub. Date: Sep. 29, 2016

(54) Composition based on oxides of zirconium, cerium, niobium and tin, preparation processes and use in catalysis

(71) Applicant: RHODIA OPERATIONS, Aubervilliers (FR)

(72) Inventors: Laure Jeanne Simone BISSON, Paris (FR); Rui Miguel JORGE COELHO MARQUES, La Rochelle (FR); Fabien OCAMPO, Bobigny (FR); Virginie HARLE, Senlis (FR); Julien HERNANDEZ, Antony (FR)

(21) Appl. No.: 14/778,176

(22) PCT Filed: Mar. 12, 2014
(86) PCT No.: PCT/EP2014/054832

§ 371 Date: Sep. 18, 2015

(30) Foreign Application Priority Data
Mar. 19, 2013 (FR) 13 00629

(51) Int. Cl. B01J 23/20; B01D 53/94; B01J 37/03; B01J 37/10; B01J 29/06; B01J 37/04

(52) U.S. Cl. CPC B01J 23/20; B01J 29/06; B01J 37/04; B01J 37/031; B01J 37/10; B01D 53/9413; B01D 2255/407

(57) ABSTRACT

The composition of the invention is based on oxides of zirconium, cerium, niobium and tin in proportions by weight of oxide of between 5% and 50% for cerium oxide, 5% and 20% for niobium oxide, 1% and 10% for tin oxide and the remainder being zirconium oxide. The composition may be used in a catalytic system for an SCR-type process for treating a gas that contains nitrogen oxides (NOx).

The present invention relates to a composition based on oxides of zirconium, cerium, niobium and tin, to the processes for preparing same and to the use thereof in catalysis, in particular for the treatment of exhaust gases.

It is known that the engines of motor vehicles emit gases containing nitrogen oxides (NOx) which are harmful to the environment. It is therefore necessary to treat these oxides in order to convert them into nitrogen.

A known method for this treatment is the SCR (Selective Catalytic Reduction) process in which the reduction of the NOx is carried out by ammonia or an ammonia precursor such as urea.

In order for it to be implemented, the SCR process requires a catalyst which, in order to be effective, must have reducibility and acidity properties.

As it happens, in the current state of the art, this effectiveness must be improved. This is because the catalytic systems currently used for implementing the SCR process are often effective only for temperatures above 250° C. It would therefore be advantageous to have catalysts which can exhibit significant activity at temperatures of about 250° C.

The object of the invention is therefore to provide catalysts which are more effective for SCR catalysis and which have improved reducibility and/or acidity properties.

With this objective, the composition of the invention is a composition based on oxides of zirconium, cerium, niobium and tin in the following proportions by weight of oxide:
cerium oxide: between 5% and 50%;
niobium oxide: between 5% and 20%;
tin oxide: between 1% and 10%;
the remainder being zirconium oxide.

Other characteristics, details and advantages of the invention will become even more fully apparent on reading the description which will follow and various concrete but non-limiting examples intended to illustrate it and the appended drawing in which:

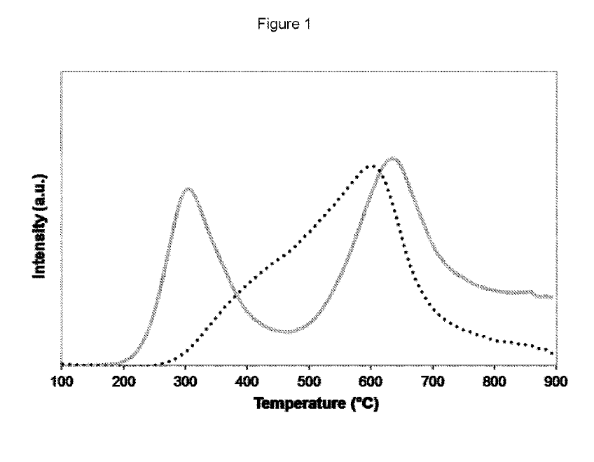

FIG. 1 represents curves of measurement by temperature programmed reduction (TPR) for a product according to the invention and a comparative product.

For the present description, the term “specific surface area” is intended to mean the BET specific surface area determined by nitrogen adsorption in accordance with the standard ASTM D 3663-78 drawn up from the Brunauer-Emmett-Teller method described in the periodical “The Journal of the American Society”, 60, 309 (1938).

The specific surface area values that are indicated for a given temperature and a given duration correspond, unless otherwise indicated, to calcinations under air at a stationary phase at this temperature and over the duration indicated.

The calcinations mentioned in the description are calcinations under air unless otherwise indicated. The calcination time that is indicated for a temperature corresponds to the duration of the stationary phase at this temperature.

The expression “rare earth element” is intended to mean the elements of the group consisting of yttrium and the elements of the Periodic Table with an atomic number between 57 and 71 inclusive.

The contents or proportions are given by weight and in terms of oxide (in particular CeO₂, SnO₂, Ln₂O₃, Ln denoting a trivalent rare earth element, Pr₆O₁₁ in the particular case of praseodymium, Nb₂O₅ in the case of niobium) unless otherwise indicated.

It is also specified, for the continuation of the description, that, unless otherwise indicated, in the ranges of values which are given, the values at the limits are included.

The composition of the invention is characterized by the nature and the proportions of its constituents.

Thus, it is based on zirconium, cerium, niobium and tin, these elements being present in the composition generally in the form of oxides. However, it is not out of the question for it to be possible for these elements to be present at least partly in another form, for example in the form of hydroxides or of oxyhydroxides.

These elements are, moreover, present in the specific proportions that were given above.

The proportion by weight of cerium oxide of the composition can be in particular between 5% and 40%, more particularly between 10% and 40% or 15% and 40% and even more particularly between 10% and 30%.

The proportion by weight of niobium oxide of the composition can be more particularly between 5% and 15% and even more particularly between 5% and 10%. Below 5%, a low effectiveness of the composition is noted and, above 20%, no further improvement of the effectiveness is noted.

The proportion by weight of tin oxide can be more particularly between 2% and 8% and even more particularly between 4% and 6%.

According to one particular embodiment of the invention, the zirconium oxide content can more particularly be between 50% and 85% and even more particularly between 65% and 80%.

According to an advantageous variant of the invention, the composition exhibits the following proportions in combination:
cerium oxide between 10% and 25%;
niobium oxide between 5% and 15%;
tin oxide between 4% and 6%;
zirconium oxide between 50% and 85%.

According to another embodiment of the invention, the composition of the invention also contains at least one element M selected from the group consisting of tungsten, molybdenum, iron, copper, silicon, aluminum, manganese, titanium, vanadium, and rare earth elements other than cerium.

As for the other elements, described above, of the composition, the element M is present in the composition generally in the form of oxide, but other forms (hydroxides or oxyhydroxides) are not excluded.

This element M can in particular act as a stabilizer of the specific surface area of the composition or further improve the reducibility thereof. For the remainder of the description, it should be understood that, if in the interests of simplification, mention is made only of an element M, it is clearly understood that the invention applies to the case where the compositions comprise several elements M.

The proportion of element M, expressed by weight of oxide of this element relative to the whole composition, is at most 20%.

The maximum proportion of oxide of the element M in the case of rare earth elements and of tungsten can be more particularly at most 15% and even more particularly at most 10% by weight of oxide of the element M (rare earth element and/or tungsten). The minimum content is at least 1%, more particularly at least 2%.

In the case where M is neither a rare earth element nor tungsten, the content of the oxide of the element M can be more particularly at most 10% and even more particularly at most 5% The minimum content can be at least 1%.

The invention also relates to the case where the composition consists essentially of the abovementioned elements zirconium, cerium, niobium, tin and, where appropriate, element M. The term “essentially consists” is intended to mean that the composition under consideration contains only the abovementioned elements, in the forms mentioned above, and that it does not contain any other functional element, i.e. element capable of having a positive influence on the catalytic action, the acidity, the reducibility and/or the stability of the composition. On the other hand, the composition may contain elements such as impurities that can in particular come from its preparation process, for example raw materials or starting reagents used.

According to one preferred embodiment of the invention, the compositions are in the form of a solid solution of the oxides of niobium, cerium, tin and, where appropriate, the element M in zirconium oxide. In this case, the presence of a single phase is then observed in X-ray diffraction corresponding to a tetragonal or cubic zirconium oxide-type phase. This single phase can occur for compositions having undergone calcinations up to a temperature of 1000° C.

The compositions of the invention have a specific surface area that is sufficiently stable, i.e. sufficiently high at high temperature, for it to be possible for them to be used in the catalysis field.

Thus, generally, the compositions of the invention can exhibit a specific surface area, after calcination for 4 hours at 800° C., which is at least 25 m²/g, more particularly at least 30 m²/g and even more particularly at least 40 m²/g.

The compositions of the invention have the advantageous characteristic of having an improved mobility of their oxygen atoms. This improved mobility gives them advantageous reducibility properties and improved effectiveness in their use in catalysis.

This mobility can be demonstrated by measuring the ability to absorb hydrogen. This measurement is carried out by temperature-programmed reduction in a known manner and under conditions which will be described more specifically later in the description. This measurement makes it possible to monitor the change in hydrogen absorption as a function of temperature. In the case of the compositions of the invention, the measurement makes it possible to demonstrate two reducibility peaks corresponding to a maximum hydrogen absorption.

One of these peaks is located at a temperature of approximately 600° C., while the second is located at a temperature of approximately 300° C.

The acidity properties of the compositions of the invention are measured by their ability to store ammonia.

The compositions of the invention can be prepared by various processes that will be described below.

A first process is characterized in that it comprises the following steps:
(a1)) a mixture in a liquid medium containing a cerium compound, a zirconium compound and, where appropriate, a compound of the element M is prepared;
(b1) said mixture is brought together with a basic compound, whereby a suspension containing a precipitate is obtained;
(c1) the suspension obtained at the end of step (b1) is heated;
(d1) the medium obtained at the end of step (c1) is mixed with a solution of a niobium salt and a solution of a tin salt, this mixing being carried out under basic conditions;
(e1) using the medium obtained at the end of step (d1), the solid is separated from the liquid phase;
(f1) said solid is calcined.

The first step of the process therefore consists in preparing a mixture of a zirconium compound, a cerium compound and, optionally, at least one compound of the element M in the case of the preparation of a composition containing at least one element of this type.

The liquid medium is preferably water.

The compounds are preferably soluble compounds. They may in particular be zirconium salts, cerium salts and salts of the element M. These compounds can be selected in particular from nitrates, sulfates, acetates, chlorides and ceric ammonium nitrates.

Mention may thus be made, as examples, of zirconium sulfate, zirconyl nitrate or zirconyl chloride. Zirconyl nitrate is most generally used. Mention may also be made in particular of cerium IV salts, such as the nitrate or the ceric ammonium nitrate for example, which are particularly suitable for use herein.

It is also possible to use a sol as zirconium or cerium starting compound. The term “sol” denotes any system consisting of fine solid particles of colloidal dimensions, i.e. dimensions between approximately 1 nm and approximately 500 nm, based on a zirconium or cerium compound, this compound generally being a zirconium or cerium oxide and/or a hydrated zirconium or cerium oxide, in suspension in an aqueous liquid phase, it being possible for said particles to also optionally contain residual amounts of bound or adsorbed ions, for instance nitrates, acetates, chlorides or ammoniums. It will be noted that, in such a sol, the zirconium or the cerium may be either totally in the form of colloids, or simultaneously in the form of ions and in the form of colloids.

Finally, it will be noted that, when the starting mixture contains a cerium compound in which said cerium is in Ce III form, it is preferable to involve an oxidizing agent, for example aqueous hydrogen peroxide, in the course of the process. This oxidizing agent can be used by being added to the reaction medium during step (a1)) or during step (b1), in particular at the end of said step.

The mixture may be obtained, without implied distinction, either from compounds that are initially in the solid state, which will be subsequently introduced into a water feedstock, for example, or directly from solutions of these compounds followed by mixing, in any order, of said solutions.

In the second step of the process, the mixture obtained in step (a1)) is brought together with a basic compound. Use may be made, as base or basic compound, of the products of the hydroxide type. Mention may be made of alkali metal or alkaline-earth metal hydroxides. Use may also be made of secondary, tertiary or quaternary amines. However, the amines and ammonia may be preferred insofar as they reduce the risks of contamination by alkali metal or alkaline-earth metal cations. Mention may also be made of urea. The basic compound is generally used in the form of an aqueous solution.

The way in which the mixture is brought together with the solution, i.e. the order in which they are introduced, is not critical. However, this bringing together can be carried out by introducing the mixture into the solution of the basic compound. This variant is preferable for obtaining the compositions in the form of solid solutions.

The next step of the process is the step of heating or maturing (c1) the suspension obtained at the end of the previous step.

This heating may be performed directly on the suspension obtained after reaction with the basic compound or on a suspension obtained after separating the precipitate from the reaction medium, optional washing of the precipitate and placing the precipitate back in water. The temperature to which the medium is heated is at least 100° C. and even more particularly at least 130° C. The heating operation may be performed by introducing the liquid medium into a closed chamber (closed reactor of the autoclave type). Under the temperature conditions given above, and in aqueous medium, it may be pointed out, by way of illustration, that the pressure in the closed reactor may range between a value greater than 1 bar (10⁵ Pa) and 165 bar (1.65×10⁷ Pa), preferably between 5 bar (5×10⁵ Pa) and 165 bar (1.65×10⁷ Pa). It is also possible to carry out the heating in an open reactor for temperatures in the vicinity of 100° C.

The heating can be carried out either under air or under an inert gas atmosphere, preferably nitrogen.

The duration of the heating can vary within wide limits, for example between 1 and 48 hours, preferably between 2 and 24 hours.

Several heating operations may be performed. Thus, the precipitate obtained after the heating step and optionally a washing operation may be resuspended in water and then another heating operation may be performed on the medium thus obtained. This other heating operation is carried out under the same conditions as those which were described for the first.

The next step of the process, step (d1), consists in mixing the medium obtained at the end of step (c1) with a solution of a niobium salt and a solution of a tin salt, this mixing being carried out under basic conditions.

As tin and niobium salts, use may be made of halides, carboxylates, in particular acetates, oxalates, tartrates, ethyl hexanoates or acetylacetonates, sulfates and, for tin, organotin compounds such as mono-, di- or trialkyltin oxides or chlorides, in particular the methyls and ethyls. For the halides, mention may more particularly be made of the chloride. The tin chloride is more generally used in the form of a hydrated salt. However, carboxylates and more particularly oxalates may be preferred since they reduce the risk of pollution by halides. Use may in particular be made of a salt or a solution of tin in oxidation state IV, but the use of tin in oxidation state II is also possible.

The mixing with the solutions of niobium salts and tin salts can be carried out in any way and in several steps. For example, the medium resulting from step (c1) can be mixed firstly with the tin solution and then, secondly, with the niobium solution. The mixing can also be carried out in the reverse order or else simultaneously, the two solutions being mixed at the same time with the abovementioned medium.

This mixing must be carried out in a basic medium, preferably at a pH of at least 9. If the medium is not basic, its pH can be adjusted by introducing into said medium a basic compound of the abovementioned type.

The next step of the process consists in separating, by any known means, the solid from the liquid phase using the medium obtained at the end of step (d1).

The solid can optionally be washed.

Finally, in a last step, the solid is calcined.

This calcination makes it possible to develop the crystallinity of the product formed and it can also be adjusted and/or chosen according to the subsequent temperature of use intended for the composition according to the invention, this being done while taking into account the fact that the specific surface area of the product decreases as the calcination temperature employed increases. Such a calcination is generally carried out under air, but a calcination carried out, for example, under an inert gas or under a controlled atmosphere (oxidizing or reducing) is very clearly not excluded.

In practice, the calcination temperature is generally restricted to a range of values between 300° C. and 900° C.

Moreover, the compositions of the invention can be prepared by means of a second process which is an impregnation process.

Thus, a preprepared composition of zirconium, cerium and niobium oxides is impregnated with a solution of a tin salt. The tin salts that were described above can be used here.

A preprepared composition based on zirconium, cerium and tin oxides can also be impregnated with a niobium solution. The niobium salts that were described above can be used here.

According to a first variant and in the case of the preparation of a composition which also comprises an oxide of the element M, a solution which contains a salt of this element M in addition to the niobium or tin salt can be used for the impregnation. The element M may also be present in the zirconium, cerium, niobium or tin oxide-based composition to be impregnated.

Dry impregnation is more particularly used. Dry impregnation consists in adding, to the product to be impregnated, a volume of a solution of the impregnating element which is equal to the pore volume of the solid to be impregnated.

According to a second variant and in the case of the impregnation of a composition of zirconium, cerium and niobium oxides with optionally an oxide of the element M, the latter composition can be prepared by carrying out a process which comprises the following steps:
(a2) a mixture in a liquid medium containing a cerium compound, a zirconium compound and, where appropriate, a compound of the element M is prepared;
(b2) said mixture is brought together with a basic compound, whereby a suspension containing a precipitate is obtained;
(c2) the suspension obtained at the end of step (b2) is heated;
(d2) the medium obtained at the end of step (c2) is mixed with a solution of a niobium salt, this mixing being carried out under basic conditions;
(e2) using the medium obtained at the end of step (d2), the solid is separated from the liquid phase;
(f2) said solid is calcined, whereby the composition is obtained.

According to a third variant and in the case of the impregnation of a composition based on zirconium, cerium and tin oxides with optionally an oxide of the element M, said composition can be prepared by carrying out a process which comprises the following steps:
(a3) a mixture in a liquid medium containing a cerium compound, a zirconium compound and, where appropriate, a compound of the element M is prepared;
(b3) said mixture is brought together with a basic compound, whereby a suspension containing a precipitate is obtained;
(c3) the suspension obtained at the end of step (b3) is heated;
(d3) the medium obtained at the end of step (c3) is mixed with a solution of a tin salt, this mixing being carried out under basic conditions;
(e3) using the medium obtained at the end of step (d3), the solid is separated from the liquid phase;
(f3) said solid is calcined, whereby the composition is obtained.

What has been described above for each step (a1), (b1), (c1), (d1), (e1) and (f1) applies likewise to steps (a2) or (a3), (b2) or (b3), (c2) or (c3), (d2) or (d3), (e2) or (e3) and (f2) or (f3) respectively.

The invention also relates to a catalytic system which comprises a composition based on zirconium, cerium, niobium and tin oxides, as described above. In this system, the composition is generally mixed with a material commonly employed in the field of catalyst formulation, i.e. a material selected from thermally inert materials. This material can thus be selected from alumina, titanium oxide, cerium oxide, zirconium oxide, silica, spinels, silicates, crystalline silicoaluminum phosphates and crystalline aluminum phosphates.

Generally, the catalytic system consists of the abovementioned mixture deposited on a substrate. More specifically, the mixture of the composition and of the thermally inert material constitutes a coating (wash coat) having catalytic properties and this coating is deposited on a substrate of, for example, the metal monolith type, for example FeCr alloy, or made of ceramic, for example of cordierite, silicon carbide, alumina titanate or mullite.

This coating is obtained by mixing the composition with the thermally inert material, so as to form a suspension which can subsequently be deposited on the substrate.

According to another embodiment, the catalytic system can be based on the composition as described previously, said composition being used in an extruded form. It can thus be in the form of a monolith having a honeycomb structure or in the form of a monolith of particulate filter type (partly closed channels). In these two cases, the composition of the invention can be mixed with additives of known type so as to facilitate the extrusion and to guarantee the mechanical strength of the extruded material. Such additives can be selected in particular from silica, alumina, clays, silicates, titanium sulfate, and ceramic fibers, in particular in proportions that are generally used, i.e. up to approximately 30% by weight relative to the whole of the composition.

The invention also relates to a catalytic system as described above and which also contains a zeolite.

The zeolite may be natural or synthetic and it may be of aluminosilicate, aluminophosphate or silicoaluminophosphate type.

A zeolite which has undergone a treatment for the purpose of improving its stability at high temperature is preferably used. As an example of treatment of this type, mention may be made of (i) dealumination by steam treatment and acid extraction using an acid or a complexing agent (for example EDTA—ethylenediaminetetracetic acid); by treatment with an acid and/or a complexing agent; by treatment with a gas stream of SiCl₄; (ii) cationic exchange using polyvalent cations such as La; and (iii) the use of phosphorus-containing compounds.

According to another particular embodiment of the invention and in the case of a zeolite of aluminosilicate type, this zeolite can have an Si/Al atomic ratio of at least 10, more particularly of at least 20.

According to a more particular embodiment of the invention, the zeolite comprises at least one other element selected from the group consisting of iron, copper and cerium.

The expression “zeolite comprising at least one other element” is intended to mean a zeolite in the structure of which one or more metals of the abovementioned type have been added by ion exchange, impregnation or isomorphic substitution.

In this embodiment, the metal content may be between approximately 1% and approximately 5%, said content being expressed by weight of metal element relative to the zeolite.

As zeolites of the aluminosilicate type which can be part of the make-up of the composition of the catalytic system of the invention, mention may more particularly be made of those selected from the group consisting of beta-zeolites, gamma-zeolites, ZSM 5, ZSM 34, chabazite and ferrierite. For the zeolites of aluminophosphate type, mention may be made of those of the SAPO-17, SAPO-18, SAPO-34, SAPO-35, SAPO-39, SAPO-43 and SAPO-56 type.

In the catalytic system of the invention, the percentage by weight of zeolite relative to the total weight of the composition can range from 10% to 70%, more preferentially from 20% to 60% and even more preferentially from 30% to 50%.

For the implementation of this variant with zeolite of the catalytic system, simple physical mixing of the composition based on cerium, zirconium, tin and niobium and of the zeolite can be carried out.

This variant of the invention using the combination of a zeolite as described above and of the composition of the invention confers improved activity on the catalytic system of the invention with regard to NOx reduction.

The invention also relates to a process for treating a gas containing nitrogen oxides (NOx), in which a reaction for reduction of the NOx with a nitrogenous reducing agent is carried out, and in which a composition or a catalytic system as described above is used as catalyst of this reduction reaction.

The gas treatment process of the invention is an SCR-type process, the implementation of which is well known to those skilled in the art.

It may be recalled that this process uses, as NOx-reducing agent, a nitrogenous reducing agent which may be ammonia, hydrazine or any appropriate ammonia precursor, such as ammonium carbonate, urea, ammonium carbamate, ammonium hydrogen carbonate, ammonium formate, or else ammonia-containing organometallic compounds. Ammonia or urea may be more particularly chosen.

Several chemical reactions can be carried out in the SCR process for the reduction of NOx to elemental nitrogen. Some of the reactions which may take place are given below and by way of example only, ammonia being the reducing agent.

A first reaction can be represented by equation (1):

4NO+4NH₃+O₂→4N₂+6H₂O (1)

Mention may also be made of the reaction of NO₂ present in the NOx with NH₃ according to equation (2):

3NO₂+4NH₃→(7/2)N₂+6H₂O (2)

Furthermore, the reaction between NH₃ and NO and NO₂ can be represented by equation (3):

NO+NO₂+2NH₃→2N₂+3H₂O (3).

The process can be carried out for the treatment of a gas originating from a (mobile or stationary) internal combustion engine, in particular from a motor vehicle engine, or of gas originating from a gas turbine, from coal-fired or fuel-oil-fired power stations or from any other industrial plant.

According to one particular embodiment, the process is used for treating the exhaust gas of a motor vehicle engine which may be more particularly a lean-burn engine or a diesel engine.

The process can also be carried out using, in addition to the composition of the invention, another catalyst which is a catalyst for oxidation of the nitrogen monoxide of the gas to nitrogen dioxide. In such a case, the process is used in a system in which this oxidation catalyst is placed upstream of the point of injection of the nitrogenous reducing agent into the gas to be treated, which can in particular be an exhaust gas.

This oxidation catalyst can comprise at least one metal of the group of platinum, for instance platinum, palladium or rhodium, on a support of alumina, ceria, zirconia or titanium oxide type for example, the catalyst/support assembly being included in a coating (wash coat) on a substrate of monolith type in particular.

According to one variant of the invention and in the case of an exhaust circuit fitted with a particulate filter intended to stop the carbon-based or soot particles generated by the combustion of the various combustible fuels, it is possible to carry out the gas treatment process of the invention by placing the catalytic system which has been described above on this filter, for example in the form of a wash coat deposited on the walls of the filter. It is observed that the use of the compositions of the invention according to this variant makes it possible in addition to reduce the temperature starting from which the particle combustion begins.

Examples will now be given.

Measurement of the Degree of NOx Conversion

For the examples, the degree of NOx conversion is measured in the following way.

A synthetic gas mixture is passed over the composition, said gas mixture having the composition below:

| | | |
|---|---|---|
| NH₃ | 1000 | vpm |
| NO | 500 | vpm |
| O₂ | 13 | vol % |

| | |
|---|---|
| N₂ | remainder |

The NOx conversion as a function of the temperature of the gas mixture is followed. The increase in temperature of the mixture is carried out at a speed of 4° C./min with a stationary phase of 20 min every 20° C. between 150° C. and 250° C.

Measurement of Hydrogen Absorption Capacity

For the examples, the measurement of the hydrogen absorption capacity is carried out by temperature-programmed reduction (TPR) in the following way. A Micromeritics Autochem 2 instrument and a sample which has been precalcined at 800° C. for 4 hours under air are used.

Hydrogen is used as reducing gas at 10% by volume in argon with a flow rate of 30 ml/min.

The experimental protocol consists in weighing out 200 mg of the sample in a pretared container.

The sample is then introduced into a quartz cell containing quartz wool in the bottom. Finally, the sample is covered with quartz wool and placed in the oven of the measuring device.

The temperature program is the following:
rise in temperature from ambient temperature up to 900° C. with a rise gradient of 20° C./min under H₂ at 10 vol % in Ar.

During this program, the temperature of the sample is measured using a thermocouple placed in the quartz cell above the sample.

The hydrogen consumption during the reduction phase is deduced by virtue of the calibration of the variation in the thermal conductivity of the gas stream measured at the outlet of the cell using a thermal conductivity detector (TCD).

The hydrogen consumption is measured between 30° C. and 900° C.

Raw Materials

For all the examples:
Niobium ammonium oxalate at a concentration of Nb₂O₅ of 28.3% by weight, from the company CBMM
Tin(II) oxalate at a concentration of SnO₂ of 72.3%, from the company Fluka
30% (110 volumes) hydrogen peroxide (aqueous hydrogen peroxide) at 9.8 mol/l, d=1.11, from the company VWR
Zirconium nitrate in solution at 274 g/l
Cerium(IV) nitrate in solution at 254 g/l.

For comparative example 1:
Tin(II) chloride hydrate of formula: SnCl₂.5H₂O purity 98% at a concentration of SnO₂ of 42.1% by weight, from the company Sigma-Aldrich
Zirconium nitrate in solution at 270 g/l
Cerium(III) nitrate in solution at 496 g/l.

### COMPARATIVE EXAMPLE 1

This example concerns the preparation of a mixed oxide of cerium, zirconium and tin in the respective proportions by weight of 42.6%, 53.1% and 4.3%.

94.5 g of cerium III nitrate solution, 167.4 g of zirconium nitrate solution and 6.53 g of tin chloride hydrate powder are introduced into a beaker and with magnetic stirring. A solution of aqueous ammonia is prepared using 156 ml of a concentrated (28%) aqueous ammonia solution in 147 g of deionized water, to which 97 ml of a 30% concentrated hydrogen peroxide solution are added. This basic solution is introduced into a 1 l reactor equipped with a stirrer and a condenser. The nitrate solution previously prepared is gradually introduced into the reactor with stirring.

The suspension obtained is filtered, and then the cake obtained is washed twice with an ammoniacal solution. The washed cake is re-dispersed in water and the suspension is transferred into an autoclave in order to undergo maturing with stirring, for 2 h at 150° C. The mixture is then cooled to ambient temperature. The suspension obtained is filtered, and then the cake obtained is washed twice with an ammoniacal solution.

The solid product obtained is dried overnight at 120° C. and then calcined at 500° C. for 4 hours.

### COMPARATIVE EXAMPLE 2

This example concerns the preparation of a mixed oxide of cerium, zirconium and niobium in the respective proportions by weight of 18%, 72% and 10%.

495 g of zirconium nitrate and 135 g of cerium(IV) nitrate are introduced into a beaker and with magnetic stirring so as to obtain an initial oxide concentration of 120 g/l. A 1-liter solution of aqueous ammonia having a concentration of 3 N is prepared using 177 g of a concentrated aqueous ammonia solution (29.8% of NH₃) in 798 g of deionized water, and then introduced into a 2-liter reactor equipped with a stirrer and a condenser. The nitrate solution is gradually introduced into the reactor with stirring.

The suspension obtained is transferred into an autoclave in order to undergo maturing with stirring, for 2 h at 150° C. The mixture is then cooled to ambient temperature.

In parallel, a solution of niobium(V) ammonium oxalate is prepared by dissolving 32.5 g of niobium(V) ammonium oxalate in 318 g of deionized water. The Nb₂O₅ concentration of this solution is 3.8%.

The niobium(V) ammonium oxalate solution is then gradually introduced into the 2 l reactor with stirring, the stirring being maintained for 15 min after the end of the addition of the oxalate solution.

The suspension is filtered, and the solid product obtained is washed and calcined at 800° C. for 4 hours.

### EXAMPLE 3

This example concerns the preparation of a composition according to the invention based on cerium oxide, zirconium oxide, niobium oxide and tin oxide in the respective proportions by weight of 17.3%, 69.1%, 9.6% and 4.0%. This preparation is carried out according to the first process described above.

495 g of zirconium nitrate and 135 g of cerium nitrate are introduced into a beaker and with magnetic stirring so as to obtain an initial oxide concentration of 120 g/l. A 1-liter solution of aqueous ammonia having a concentration of 3 N is prepared using 177 g of a concentrated aqueous ammonia solution (29.8% of NH₃) in 798 g of deionized water, and then introduced into a 2-liter reactor equipped with a stirrer and a condenser. The nitrate solution is gradually introduced into the reactor with stirring.

The suspension obtained is transferred into an autoclave in order to undergo maturing with stirring, for 2 h at 150° C. The mixture is then cooled to ambient temperature.

In parallel, a solution of niobium(V) ammonium oxalate is prepared by dissolving 47.1 g of niobium(V) ammonium oxalate in 195 g of deionized water. The Nb₂O₅ concentration of this solution is 5.5%.

Likewise, a solution of tin(IV) oxalate is prepared by suspending, with magnetic stirring, 7.7 g of insoluble tin(II) oxalate in 79.6 g of deionized water, followed by dissolution by adding 4.2 g of 30% hydrogen peroxide solution, causing a phenomenon of oxidation of the Sn(II) and Sn(IV) species. The SnO₂ concentration of this solution is 6.1%.

The tin oxalate solution is added to the niobium ammonium oxalate solution. The resulting solution is then gradually introduced into the 2 l reactor with stirring, the stirring being maintained for 15 min after the end of the addition of the oxalate solution.

The suspension is filtered, and the solid product obtained is washed and calcined at 800° C. for 4 hours.

### EXAMPLE 4

This example concerns the preparation of a composition according to the invention based on cerium oxide, zirconium oxide, niobium oxide and tin oxide in the respective proportions by weight of 16.9%, 67.7%, 9.4% and 6.0%. This preparation is carried out by means of an impregnation process described above and according to the first variant.

A solution of tin(IV) oxalate is prepared by suspending, with stirring, 1.73 g of insoluble tin(II) oxalate in 7.5 g of deionized water, followed by dissolution by adding 0.95 g of 30% hydrogen peroxide solution, causing a phenomenon of oxidation of the Sn(II) and Sn(IV) species. The SnO₂ concentration of this solution is 12.3%.

A powder of the mixed oxide obtained according to comparative example 2 above is then impregnated with this solution until the pore volume is saturated.

The impregnated powder is then calcined at 800° C. for 4 hours.

### EXAMPLE 5

This example concerns the preparation of a composition based on cerium oxide, zirconium oxide, niobium oxide and tin oxide in the respective proportions by weight of 17.3%, 69.1%, 9.6% and 4.0%.

A solution of tin(IV) oxalate is prepared by suspending, with magnetic stirring, 1.14 g of insoluble tin(II) oxalate in 8.5 g of deionized water, followed by dissolution by adding 0.63 g of 30% hydrogen peroxide solution, causing a phenomenon of oxidation of the Sn(II) and Sn(IV) species. The SnO₂ concentration of this solution is 8.0%.

The process is then performed as in example 4.

### EXAMPLE 6

This example concerns the preparation of a composition based on cerium oxide, zirconium oxide, tin oxide and niobium oxide in the respective proportions by weight of 17.3%, 69.1%, 9.6% and 4.0%, this preparation being carried out by impregnation of a mixed oxide of zirconium, cerium and tin with a niobium solution.

Preparation of the Mixed Oxide of Zirconium, Cerium and Tin

495 g of zirconium nitrate and 135 g of cerium(IV) nitrate are introduced into a beaker and with magnetic stirring so as to obtain a solution at the initial oxide concentration of 120 g/l. A 1-liter solution of aqueous ammonia having a concentration of 3 N is prepared using 177 g of a concentrated aqueous ammonia solution (29.8% of NH₃) in 798 g of deionized water, and then introduced into a 2-liter reactor equipped with a stirrer and a condenser. The nitrate solution is gradually introduced into the reactor with stirring.

The suspension obtained is transferred into an autoclave in order to undergo maturing with stirring, for 2 h at 150° C. The mixture is then cooled to ambient temperature.

A solution of tin(IV) oxalate is prepared by suspending, with magnetic stirring, 7.7 g of insoluble tin(II) oxalate in 79.6 g of deionized water, followed by dissolution by adding 4.2 g of 30% hydrogen peroxide solution, causing a phenomenon of oxidation of the Sn(II) and Sn(IV) species. The SnO₂ concentration of this solution is 6.1%.

The tin oxalate solution is gradually introduced into the 2 l reactor.

Stirring is maintained for 15 min after addition.

The suspension is filtered, and the solid product obtained is washed and calcined at 800° C. for 4 hours.

Impregnation of the Mixed Oxide of Zirconium, Cerium and Tin

A solution of niobium(V) ammonium oxalate is prepared by dissolving, under hot conditions, 7.5 g of niobium(V) ammonium oxalate in 12.9 g of deionized water. This solution is maintained at 50° C. The Nb₂O₅ concentration of this solution is 10.4%. A powder of the mixed oxide previously prepared is then impregnated with half of this solution until the pore volume is saturated. The impregnated powder is then calcined at 400° C. for 1 hour. A second impregnation is then carried out with the remaining half of the solution, as described above. The impregnated powder is then calcined at 800° C. for 4 hours.

### EXAMPLE 7

This example concerns the preparation of a composition based on cerium oxide, zirconium oxide, niobium oxide and tin oxide in the respective proportions by weight of 38.7%, 48.2%, 9.2% and 3.9%, this preparation being carried out by impregnation of a mixed oxide of zirconium, cerium and tin with a niobium solution.

A solution of niobium(V) ammonium oxalate is prepared by dissolving, under hot conditions, 4.6 g of niobium(V) ammonium oxalate in 4.3 g of deionized water. This solution is maintained at 50° C. The Nb₂O₅ concentration of this solution is 14.7%.

20 g of powder of the mixed oxide prepared according to comparative example 1 (CeO₂/ZrO₂/SnO₂ 42.6%153.1%14.3%, specific surface area after calcination at 800° C. for 4 hours of 68 m²/g) are then impregnated with half of this solution until the pore volume is saturated.

The impregnated powder is then calcined at 400° C. for 1 hour. A second impregnation is then carried out with the remaining half of the solution, as described above. The impregnated powder is then calcined at 800° C. for 4 hours.

Tables 1 and 2 below give the specific surface areas after calcination at various temperatures for the compositions of the examples according to the invention and the degrees of NOx conversion obtained for all the examples.

TABLE 1

| | Specific surface area (m²/g) | | |
|---|---|---|---|
| | after calcination for 4 hours at | | |
| Example | 800° C. | 900° C. | 1000° C. |
| 1 | — | 31 | 9 |
| 2 | 48 | 25 | 9 |
| 3 | 49 | 23 | 8 |
| 4 | 43 | 24 | 8 |
| 5 | 45 | 24 | 8 |
| 6 | 39 | 22 | 10 |
| 7 | 31 | 12 | 3 |

The products of examples 3 to 7 are in the form of a solid solution of tetragonal zirconium oxide after calcination for 4 hours at 800° C. and 1000° C.

TABLE 2

| | NOx % conversion at | | | | |
|---|---|---|---|---|---|
| Example | 170° C. | 190° C. | 210° C. | 230° C. | 250° C. |
| 1, | 4 | 4 | 5 | 10 | 21 |
| comparative | | | | | |
| 2, | 5 | 12 | 26 | 45 | 66 |
| comparative | | | | | |
| 3 | 6 | 16 | 35 | 62 | 84 |
| 4 | 8 | 17 | 35 | 61 | 85 |
| 5 | 9 | 11 | 36 | 56 | 71 |
| 6 | 7 | 17 | 37 | 64 | 82 |
| 7 | 6 | 22 | 49 | 77 | 92 |

It is seen that the products according to the invention exhibit a greater degree of conversion than the products of the comparative examples, this being at temperatures which are at most 250° C.

Table 3 below gives the amounts of hydrogen adsorbed (VH₂) for the compositions of comparative examples 1 and 2 and for the examples according to the invention.

TABLE 3

| Example | VH₂ (ml) |
|---|---|
| 1, | 32 |
| comparative | |
| 2, | 12.4 |
| comparative | |
| 3 | 16.3 |
| 4 | 25.9 |
| 5 | 21.2 |
| 6 | 17.7 |
| 7 | 30.9 |

Table 4 below gives the temperatures at which a peak is observed in the TPR measurement curves.

TABLE 4

| Example | Temperature (° C.) |
|---|---|
| 1, comparative | 230/600 |
| 2, comparative | 600 |
| 3 | 303/634 |
| 4 | 281/597 |
| 5 | 276/593 |
| 6 | 289/658 |
| 7 | 317/645 |

It is observed that the products according to the invention exhibit two reducibility peaks, thereby reflecting greater mobility of the surface oxygen atoms for these products.

The FIGURE represents two TPR measurement curves. The continuous-line curve corresponds to the product of example 3 and the dashed-line curve corresponds to the product of comparative example 2.

1. A composition based on oxides of zirconium, cerium, niobium and tin in the following proportions by weight of oxide:
cerium oxide: between 5% and 50%;
niobium oxide: between 5% and 20%;
tin oxide: between 1% and 10%;
the remainder being zirconium oxide.

2. The composition as claimed in claim 1, wherein the cerium oxide is present in a proportion by weight of between 5% and 40%.

3. The composition as claimed in claim 2, wherein the cerium oxide is present in a proportion by weight of between 10% and 30%.

4. The composition as claimed in claim 1, wherein the niobium oxide is present in a proportion by weight of between 5% and 15%.

5. The composition as claimed in claim 1, wherein the tin oxide is present in a proportion by weight of between 2% and 8%.

6. The composition as claimed in claim 1, wherein the zirconium oxide is present in a proportion by weight of between 50% and 85%.

7. The composition as claimed in claim 1, further comprising at least one oxide of an element M selected from the group consisting of tungsten, molybdenum, iron, copper, silicon, aluminum, manganese, titanium, vanadium, and rare earth elements other than cerium, in a proportion by weight of oxide of the element M of at most 20%.

8. The composition as claimed in claim 1, wherein the composition is in the form of a solid solution of the oxides of cerium, niobium and tin in zirconium oxide.

9. The composition as claimed in claim 1, wherein the composition exhibits two reducibility peaks during the measurement of its oxygen storage capacity.

10. A process for preparing a composition as claimed in claim 1, the process comprising:
combining a mixture containing a cerium compound, a zirconium compound and, where appropriate, a compound of element M in a liquid medium;
with a basic compound to form a suspension containing a precipitate;
heating the suspension to form a first heated medium;
mixing, under basic conditions, the first heated medium with a solution of a niobium salt and a solution of a tin salt to form a first salt medium;
separating solid from the liquid phase of the first salt medium;
calcining the solid.

11. A process for preparing a composition as claimed in claim 1, the process comprising impregnating a composition based on oxides of zirconium, cerium and niobium, and optionally element M with a tin solution, wherein element M, if present, is in a solution used for impregnating or in the composition being impregnated.

12. The process as claimed in claim 11, wherein the composition based on oxides of zirconium, cerium and niobium, and optionally the element M is prepared by means of a process comprising:
combining a mixture containing a cerium compound, a zirconium compound and, where appropriate, a compound of element M in a liquid medium;
with a basic compound to form a suspension containing a precipitate;
heating the suspension to form a second heated medium;
mixing, under basic conditions, the second heated medium;
separating solid from the liquid phase of the second salt medium; and
calcining the solid.

13. A process for preparing a composition as claimed in claim 1, the process comprising impregnating a composition based on oxides of zirconium, cerium and tin, and optionally element M with a niobium solution, wherein element M, if present, is in a solution used for impregnating or in the composition being impregnated.

14. The process as claimed in claim 13, wherein the composition based on oxides of zirconium, cerium and tin, and optionally the element M is prepared by means of a process comprising:
combining a mixture containing a cerium compound, a zirconium compound and, where appropriate, a compound of element M in a liquid medium;
with a basic compound to form a suspension containing a precipitate;
heating the suspension to form a third heated medium;
mixing, under basic conditions, the third heated medium with a solution of a tin salt to form a third salt medium;
separating solid from the liquid phase of the third salt medium; and
calcining the solid.

15. The process as claimed in claim 10, wherein the heating is carried out at a temperature of at least 100° C.

16. A catalytic system, characterized in that it comprises a composition as claimed in claim 1.

17. The catalytic system as claimed in claim 16, further comprising a zeolite.

18. A process for treating a gas containing nitrogen oxides (NOx), the process comprising reducing the NOx in the gas with a nitrogenous reducing agent in the presence of a catalytic system as claimed claim 16.

19. The process as claimed in claim 18, wherein the nitrogenous reducing agent is selected from ammonia or urea.

20. The process as claimed in claim 18, wherein the gas containing nitrogen oxides (NOx) is an exhaust gas from a motor vehicle engine.
